(19) United States
(12) Patent Application Publication
(10) Pub. No.: US 2004/0164932 A1
(43) Pub. Date: Aug. 26, 2004

(54) Plasma display panel device

(75) Inventors: Eishiro Otani, Yamanashi-ken (JP); Kazuo Yahagi, Yamanashi-ken (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/784,822

(22) Filed: Feb. 24, 2004

(30) Foreign Application Priority Data
Feb. 25, 2003 (JP) 2003-47176

(51) Int. Cl. G09G 3/28

(52) U.S. Cl. 345/60

(57) ABSTRACT

A plasma display panel includes a front substrate and a rear substrate, with a discharge space therebetween. Row and column electrodes extend on an inner surface of the front substrate. Each display line is defined by paired two adjacent row electrodes. A dielectric layer covers the row electrodes. Unit light-emission areas are formed in the discharge space at intersections of the row and column electrodes. A partition wall matrix comparts the unit light-emission areas from each other. A separation wall divides each unit light-emission area into a first discharge cell, in which discharge occurs across the paired two adjacent row electrodes associated with that unit light-emission area, and a second discharge cell, in which discharge occurs across one of the paired two adjacent row electrodes and the column electrode concerned. The first discharge cell communicates with the second discharge cell via a passage in each unit light-emission area.

### BACKGROUND OF THE INVENTION

1. Field of the Invention

The present invention relates to a display device including a plasma display panel.

2. Description of the Related Art

In recent years, plasma display devices having surface-discharge type AC plasma display panels have attracted attention. The plasma display panel is one kind of large, thin color display panels. One example of the plasma display devices is disclosed in Japanese Patent Application Kokai No. 5-205642.

Referring to FIG. 1 to FIG. 3 of the accompanying drawings, a conventional surface-discharge AC plasma display panel will be briefly described. FIG. 1 illustrates a plan view showing a portion of the conventional surface-discharge AC plasma display panel. FIG. 2 illustrates a cross sectional view taken along the line II-II in FIG. 1. FIG. 3 illustrates a cross sectional view taken along the line III-III in FIG. 1.

FIG. 2 is first referred to. In a plasma display panel (PDP), discharge is caused in each of pixels between a front glass substrate 1 and a rear glass substrate 4 arranged in parallel. The surface (front-surface) of the front glass substrate 1 is the display surface. On the rear-surface side of the front glass substrate 1, a plurality of row electrode pairs X′, Y′ extend in a longitudinal direction (i.e., the width or horizontal direction) of the display panel. A dielectric layer 2 covers the row electrode pairs X′, Y′, and a protective layer (MgO layer) 3 covers the dielectric layer 2. Each row electrode X′, Y′ includes a wide transparent electrode Xa′, Ya′, made from ITO or other transparent conductive film, and a thin (narrow) bus electrode Xb′, Yb′, made from metal film. The electrode Xb′, Yb′ supplements the conductivity of the associated electrode Xa′, Ya′. As best seen in FIG. 1, the row electrodes X′ and Y′ are arranged in alternation with discharge gaps g′. The electrodes X′ and Y′ are spaced from each other in the vertical direction (or the height direction) of the display screen. Each row electrode pair X′, Y′ forms one display line (horizontal line) L of the matrix display. The row electrodes X′ and Y′ extend in parallel to each other. As illustrated in FIG. 3, a plurality of column electrodes D′ are provided on the rear glass substrate 4 such that the column electrode D′ extend in the direction orthogonal to the row electrode pairs X′, Y′. Band-shaped barrier walls 5 are formed between the column electrodes D′. The barrier walls 5 are parallel to each other. Fluorescent layers 6 formed from red (R), green (G), and blue (B) fluorescent materials cover the side faces of the barrier walls 5 and the column electrodes D′. Between the protective layer 3 and fluorescent layers 6 exist discharge spaces S′, within which is sealed an Ne—Xe gas. In each display line L (FIG. 1), discharge spaces S′ are partitioned by the barrier walls 5 at the portions of intersection of the column electrodes D′ and the row electrode pairs X′ ,Y′, to form discharge cells C′ as unit emission areas.

As one method of expressing beautifully changing halftones in a displayed image on the surface-discharge AC PDP, the so-called subfield method is employed. Specifically, the display period for one field is divided into N subfields, and each subfield emits light a number of times based on a weighting given to that subfield. Lighting subfields and non-lighting subfields are determined for the respective discharge cells, based on an input image signal. For each field, a halftone brightness is perceived in accordance with a total number of light emission from the subfields of that field.

The subfield driving method is more described with reference to FIG. 4, which illustrates driving pulses applied to the PDP in one subfield.

As shown in FIG. 4, each subfield includes an all (simultaneous) reset interval Rc, addressing interval Wc, and sustain interval Ic.

In the simultaneous reset interval Rc, reset pulses RPx and RPy are simultaneously applied to the row electrodes X₁′to Xₙ′ and Y₁′ to Yₙ′ so that reset discharge is induce simultaneously in all the discharge cells, and a certain amount of wall electric charge is formed within each of the discharge cells. Then, in the addressing interval Wc, a scan pulse SP is applied in succession to the row electrodes Y₁′ to Yₙ′, and m pixel data pulses derived from pixels of the input image data are applied, for each display line, to the column electrodes D₁′ to Dₘ′. More specifically, as shown in FIG. 4, n groups of m pixel data pulses, DP₁ to DPₙ, are applied to the column electrodes D₁′ to Dₘ′ in synchronization with the scan pulses SP for the first to n-th display lines. Address discharge (selective extinction discharge) is induced in only those discharge cells to which a high-voltage pixel data pulse is applied together with the scan pulse. The address discharge eliminates the wall electric charge in the discharge cell. In those discharge cells in which the address discharge is not induced, the wall electric charge remains. Next, in the sustain interval Ic, sustain pulses IPx, IPy are applied to the row electrodes X₁′ to Xₙ′ and Y₁′ to Yₙ′ a number of times corresponding to the subfield weighting. As a result, only discharge cells in which the wall charge remains repeat sustain discharge a number of times corresponding to the number of applied sustain pulses IPx, IPy. Due to this sustain discharge, vacuum ultraviolet light of wavelength 147 nm is emitted from the xenon (Xe) sealed within the discharge space S′. This vacuum ultraviolet light excites the red (R), green (G) and blue (B). fluorescent layers formed on the rear substrate so that visible light is emitted.

In the above described image formation in the PDP, the reset discharge is performed prior to the address discharge and sustain discharge in order to ensure stable (successful) occurrence of the address discharge and sustain discharge. Further, the address discharge is performed for each subfield. In the conventional PDP, the reset discharge and address discharge are performed within the discharge cells C′ in which visible light is emitted in order to form an image through sustained discharge. Hence light emission appears on the display screen due to reset discharge and address discharge even when expressing black and other dark image colors. This makes the screen brighter and often degrades contrast.

In addition, since the row electrodes X₁′ to Xₙ′ and Y₁′ to Yₙ′ are arranged alternately and closely, a voltage difference is created between the paired electrodes X′ and Y′ during the sustain interval even if the paired electrodes (or the display line defined by the paired electrodes) should not emit any light. In order to prevent unnecessary discharge from the non-light-emitting paired electrodes, and to reduce an electrostatic capacity between the display lines, the spacing between the display lines should be sufficiently large. If the electrostatic capacity between the display lines is large, power consumption increases. If the spacing between the display lines should be large, the fineness of the displayed image cannot be achieved. The display line pitch should be short if the fineness is desired.

### SUMMARY OF THE INVENTION

An object of the present invention is to provide a plasma display panel which can present a sharp contrast and fine image.

Another object of the present invention is to provide a display device which can create an image having sharp contrast and fineness.

According to one aspect of the present invention, there is provided an improved plasma display panel. The plasma display panel includes a front substrate and a rear substrate, with a discharge space formed therebetween. The plasma display panel also includes a plurality of row electrodes extending in the row direction on an inner surface of the front substrate. The row electrodes are parallel to each other and spaced from each other in the column direction. Each display line of the plasma display panel is defined by paired two adjacent row electrodes. One of the paired two adjacent row electrodes is used in a next paired two adjacent row electrodes to define a next display line. A dielectric layer is formed on the inner surface of the front substrate for covering the row electrodes. The plasma display panel also includes a plurality of column electrodes extending in the column direction on the inner surface of the rear substrate. The column electrodes are parallel to each other and spaced from each other in the row direction. A plurality of unit light-emission areas are formed in the discharge space at intersections of the row electrodes and column electrodes. Two row electrodes and one column electrode are associated with each unit light-emission area. A partition wall matrix is provided between the front and rear substrates for partitioning the unit light-emission areas from each other. A plurality of separation walls are also provided between the front and rear substrates such that each separation wall divides each unit light-emission area into a first discharge cell and a second discharge cell. In the first discharge cell, discharge occurs across the paired two adjacent row electrodes associated with the unit light-emission area concerned. In the second discharge cell, discharge occurs across one of the paired two adjacent row electrodes and the column electrode associated with the unit light-emission area concerned. The first discharge cell is communicated with the second discharge cell via a passage in each unit light-emission area.

According to another aspect of the present invention, there is provided an improved display device for displaying an image corresponding to an input image signal, based on pixel data of pixels derived from the input image signal. The display device is operated with a plurality of subfields. The subfields are obtained by dividing one field display period by a certain number. Each subfield includes an addressing interval and a sustain interval. The display device includes a plasma display panel. The plasma display panel includes a front substrate and a rear substrate, with a discharge space therebetween. The plasma display panel also includes parallel row electrodes extending in the row direction on an inner surface of the front substrate. The row electrodes are spaced from each other in the column direction. Each display line of the plasma display panel is defined by paired two adjacent row electrodes. One of the paired two adjacent row electrodes is used in a next paired two adjacent row electrodes to define a next display line. A dielectric layer is formed on the inner surface of the front substrate for covering the row electrodes. The plasma display panel also includes parallel column electrodes extending in the column direction on the inner surface of the rear substrate. The column electrodes are spaced from each other in the row direction. A plurality of unit light-emission areas are formed in the discharge space at intersections of the row and column electrodes. Two row electrodes and one column electrode are associated with each unit light-emission area. A partition wall matrix is provided between the front and rear substrates for partitioning the unit light-emission areas from each other. A plurality of separation walls are also provided between the front and rear substrates such that each separation wall divides each unit light-emission area into a first discharge cell, in which discharge occurs across the paired two adjacent row electrodes associated with the unit light-emission area concerned, and a second discharge cell, in which discharge occurs across one of the paired two adjacent row electrodes and the column electrode associated with the unit light-emission area concerned. The first discharge cell is communicated with the second discharge cell via a passage in each unit light-emission area. The display device includes an addressing circuit for applying a positive scan pulse to one of each paired two adjacent row electrodes in the address interval from the first display line to the last display line sequentially. The addressing circuit also applies pixel data pulses derived from the pixel data to the column electrodes, for one display line at a time, in synchronization with the positive scan pulse when the column electrodes are a cathode, thereby selectively inducing address discharge in the second discharge cells. The display device also includes a sustaining circuit for applying a sustain pulse to each paired two adjacent row electrodes in the sustain interval.

Other objects, aspects and advantages of the present invention will become apparent to those skilled in the art when the following detailed description and the appended claims are read and understood in conjunction with the accompanying drawings.

### BRIEF DESCRIPTION OF THE DRAWINGS

FIG. 1 is a plan view showing a portion of a conventional plasma display panel;

FIG. 2 shows a cross-section taken along the line II-II in FIG. 1;

FIG. 3 shows a cross-section taken along the line III-III in FIG. 1;

FIG. 4 shows various driving pulses applied to the plasma display panel within one subfield, and the application timing thereof;

FIG. 5 shows a plasma display panel (PDP) device according to one embodiment of the present invention;

FIG. 6 is a plan view showing a portion of the PDP shown in FIG. 5, seen from the display surface side (front surface side) of the PDP;

FIG. 7 illustrates a cross sectional view of the PDP of FIG. 5 taken along the line VII-VII in FIG. 6;

FIG. 8 illustrates a cross sectional view of the PDP of FIG. 5 taken along the line VIII-VIII in FIG. 6;

FIG. 9 illustrates a cross sectional view of the PDP of FIG. 5 taken along the line IX-IX in FIG. 6;

FIG. 10 illustrates a cross sectional view of the PDP of FIG. 5 taken along the line X-X in FIG. 6;

FIG. 11 shows a pixel data conversion table used in a selective erase (extinction) addressing method, and a light emission pattern determined by pixel driving data obtained from the pixel data conversion table;

FIG. 12 shows an example of a light emission driving sequence when the PDP of FIG. 5 is operated with a selective erase addressing method;

FIG. 13 shows various driving pulses applied to the PDP of FIG. 5 in a first subfield and a second subfield, and the application timing of the driving pulses;

FIG. 14 is a plan view of a part of a PDP according to another embodiment of the present invention;

FIG. 15 illustrates a cross sectional view of the PDP of FIG. 14 taken along the line XV-XV in FIG. 14;

FIG. 16 illustrates a cross sectional view of the PDP of FIG. 14 taken along the line XVI-XVI in FIG. 14;

FIG. 17 illustrates a cross sectional view of the PDP of FIG. 14 taken along the line XVII-XVII in FIG. 14;

FIG. 18 illustrates a cross sectional view of the PDP of FIG. 14 taken along the line XVIII-XVIII in FIG. 14; and

FIG. 19 illustrates a cross sectional view of the PDP of FIG. 14 taken along the line XIX-XIX in FIG. 14.

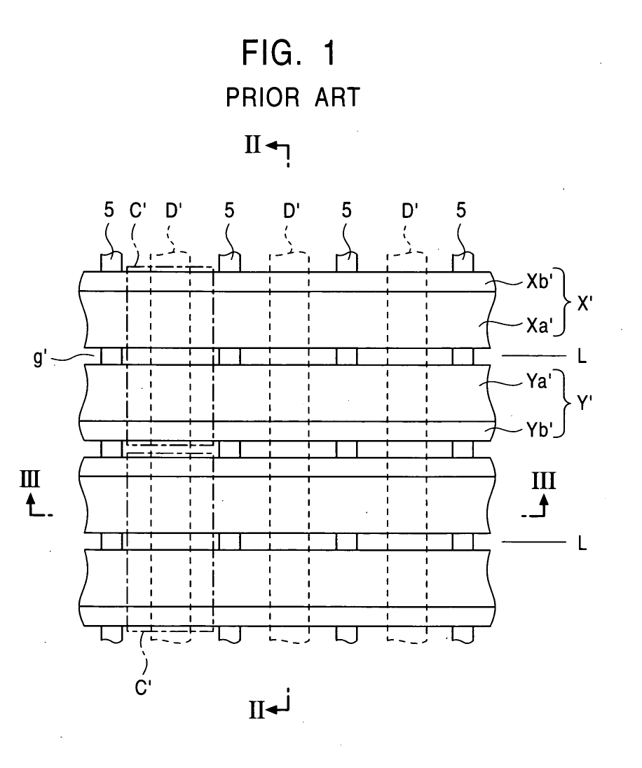

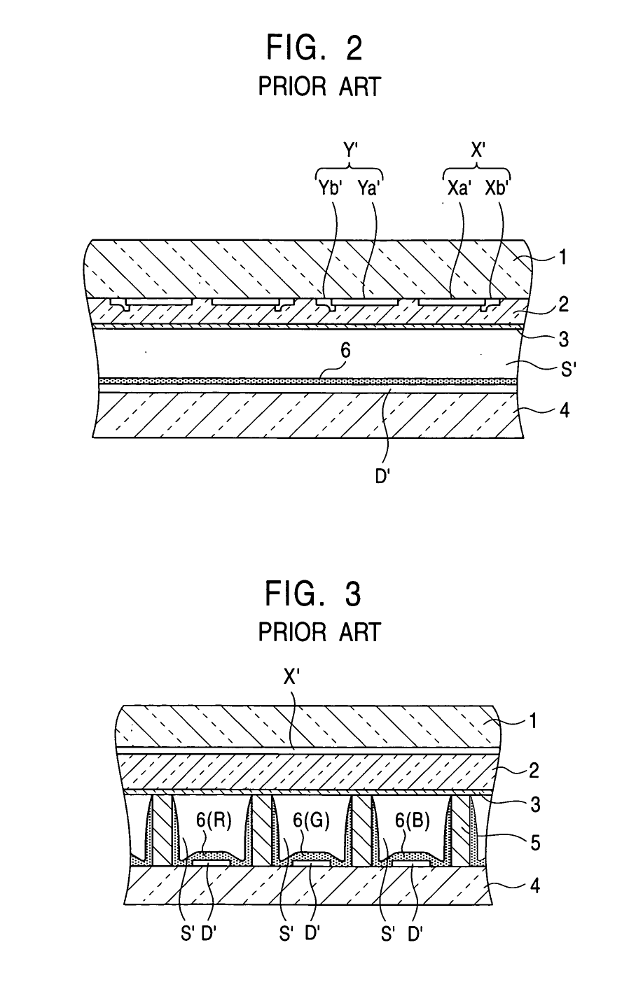

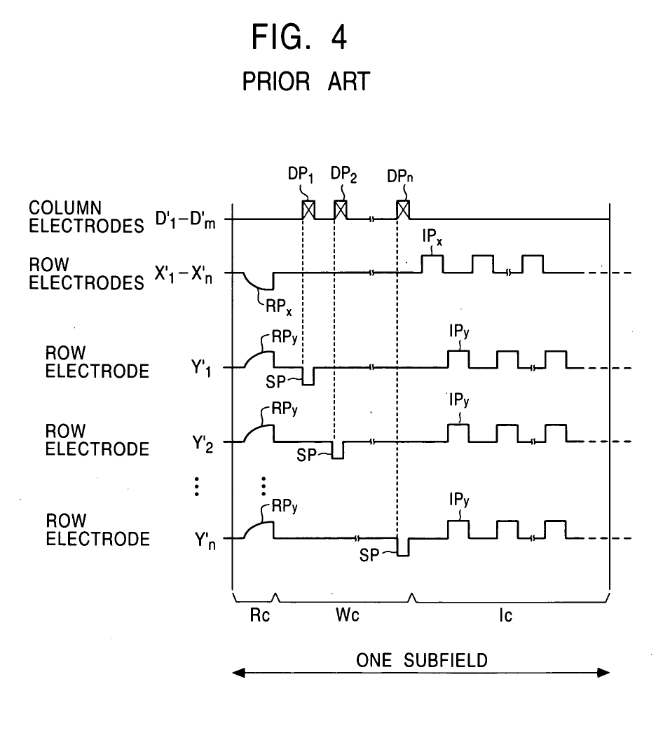

### DETAILED DESCRIPTION OF THE INVENTION

Embodiments of the present invention are described with reference to the drawings.

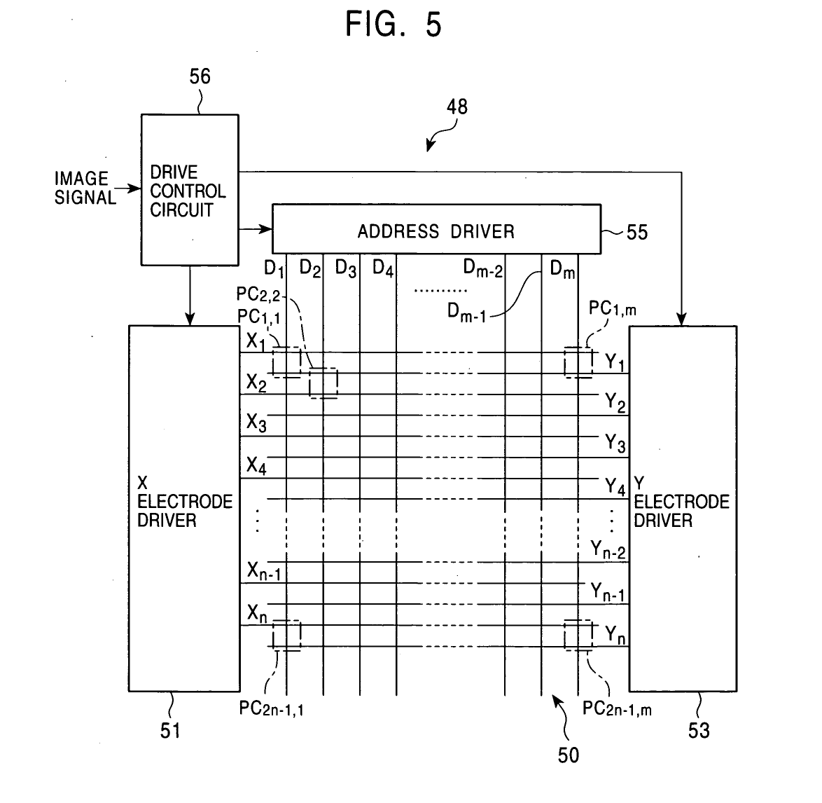

Referring first to FIG. 5, the configuration of a plasma display device 48 as a display device of the present invention is illustrated.

As shown in this drawing, the plasma display device 48 includes a plasma display panel or PDP 50, an X electrode driver 51, a Y electrode driver 53, an address driver 55, and a driving control circuit 56.

In the PDP 50, band-shaped column electrodes D₁ to Dₘ extend in the vertical direction of the display screen. Further, row electrodes X₁ to Xₙ and Y₁ to Yₙ alternately extend in the horizontal direction of the display screen. Each pair of row electrodes, that is, each of the row electrode pairs X₁,Y₁ to Xₙ,Yₙ, respectively defines one of the first display line to the 2n−1' th display line in the PDP 50. Unit emission areas, that is, pixel cells PC serving in combination as pixels, are formed at intersections of the display lines with the column electrodes D₁ to Dₘ, as indicated by the chain line square in FIG. 5. In other words, pixel cells PC are arranged in a matrix in the PDP 50 such that the pixel cells PC_{1,1} to PC_{1,m} belong to the first display line, the pixel cells PC_{2,1} to PC_{2,m} belong to the second display line, . . . , and the pixel cells PC_{2n-1,1} to PC_{2n-1,m} belong to the 2n−1'th display line

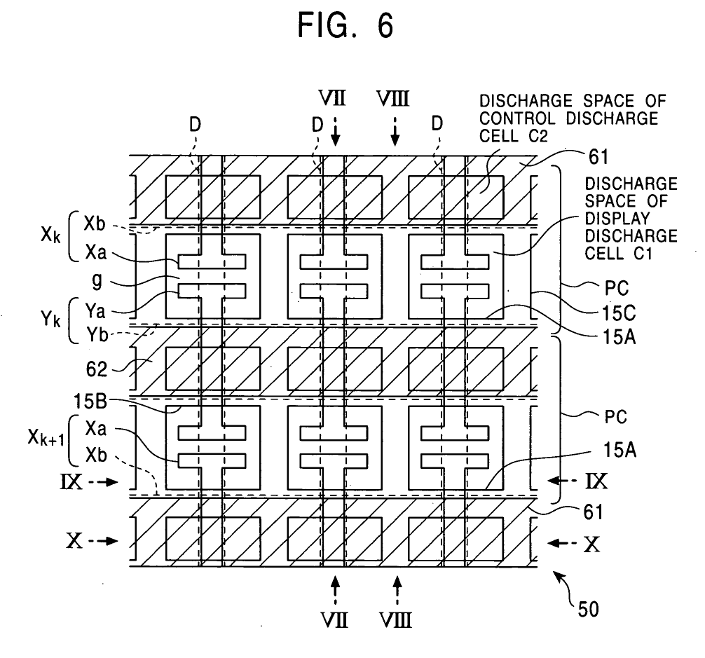

FIG. 6 to FIG. 10 are partial extracts of the internal structure of the PDP 50.

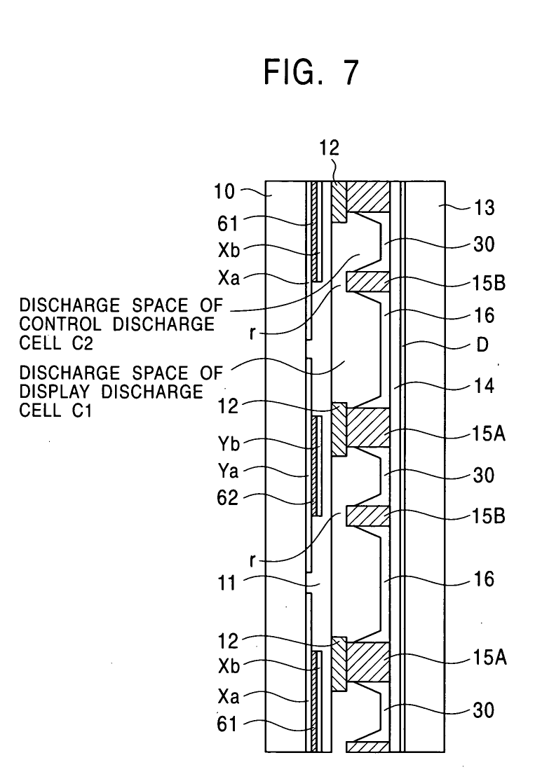

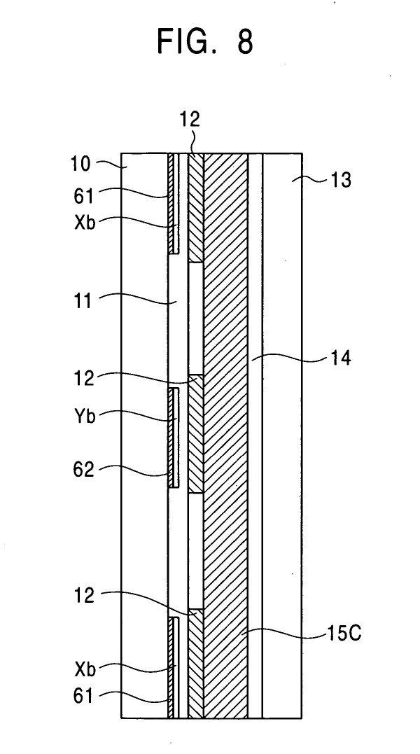

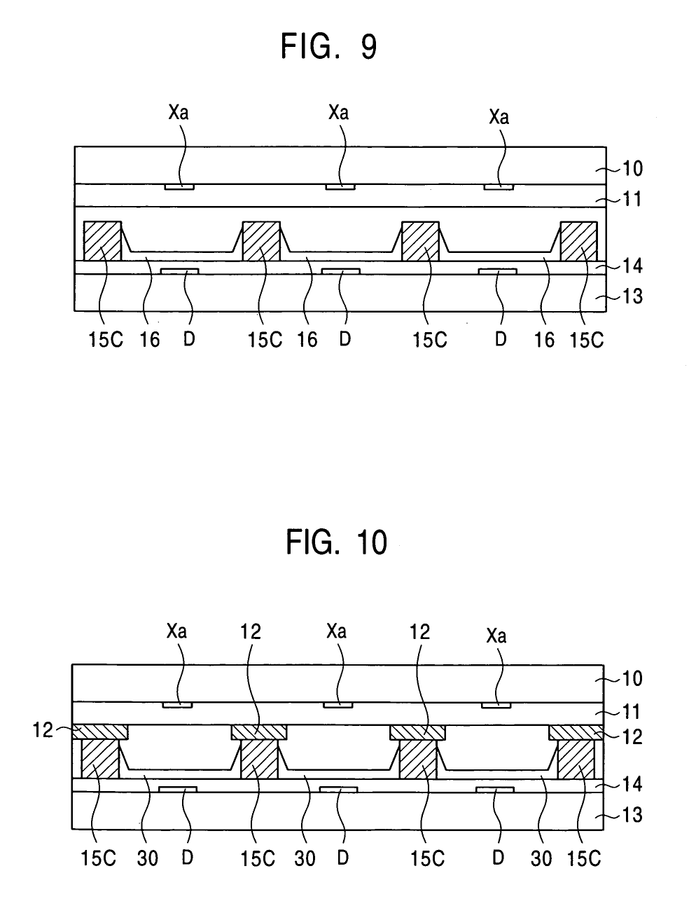

FIG. 6 is a plan view showing a portion of the PDP 50 when viewed from the display surface side (front surface side) of the PDP 50, FIG. 7 illustrates a cross sectional view of the PDP 50 taken along the line VII-VII in FIG. 6, FIG. 8 illustrates a cross sectional view of the PDP 50 taken along the line VIII-VIII in FIG. 6, FIG. 9 illustrates a cross sectional view of the PDP 50 taken along the line IX-IX in FIG. 6, and FIG. 10 illustrates a cross sectional view of the PDP 50 taken along the line X-X in FIG. 6.

The portion of the PDP 50 shown in FIG. 6 includes three column electrodes D among the column electrodes D₁ to Dₘ, two row electrodes Xₖ and Xₖ₊₁ among the row electrodes X₁ to Xₙ, and one row electrode Yₖ among the row electrodes Y₁ to Yₙ. Each row electrode Xₖ (or Xₖ₊₁) includes a plurality of transparent electrodes Xa extending in the vertical direction of the display screen (column direction), and a band-shaped bus electrode Xb (the main portion of the row electrode X) extending in the horizontal direction (row direction) of the display screen. The transparent electrode Xa has two T-shaped ends. The transparent electrodes Xa are connected to the bus electrode Xb. It can be said that a plurality of two branching portions Xa extend oppositely from the main portion Xb, and each branching portion Xa has a T shape. Likewise, each row electrode Yₖ includes a plurality of transparent electrodes Ya extending in the vertical direction of the display screen, and a band-shaped bus electrode Yb (the main portion of the row electrode Y) extending in the horizontal direction of the display screen. The transparent electrode Ya has two T-shaped ends. The transparent electrodes Ya are connected to the bus electrode Yb. It can be said that a plurality of two branching portions Ya extend oppositely from the main portion Yb, and each branching portion Ya has a T shape.

Although the transparent electrode Xa of the row electrode Xₖ (Xₖ₊₁) has two ends, only one of them is shown in FIG. 6. In other words, the transparent electrode Xa has a similar shape to the transparent electrode Ya. The transparent electrodes Xa and Ya are made from ITO or other transparent conductive film, and extend along the column electrodes D. The T-shaped ends of the mating transparent electrodes Xa and Ya are spaced from each other by a discharge gap g of prescribed value in the vertical direction of the display screen. A display discharge cell (first discharge cell) C1 is defined at a position below the discharge gap g (FIG. 7). The bus electrodes Xb and Yb are made from black or transparent metal film. A control discharge cell (second discharge cell) C2 is defined at a position below an intersection of the bus electrode Xb (Yb) and transparent electrode Xa (Ya).

As shown in FIG. 7, the transparent electrodes Xa and Ya are formed between the front glass substrate 10 and rear substrate 13 of the PDP 50. The front glass substrate 10 serves as the display surface (front face) of the PDP 50. The front glass substrate 10 is parallel to the rear substrate 13. A light-absorbing layer 61 is formed between the transparent electrode Xa and bus electrode Xb. The light-absorbing layer 61 has a similar shape to the bus electrode Xb. Likewise, a light-absorbing layer 62 is formed between the transparent electrode Ya and bus electrode Yb. The light-absorbing layer 62 has a similar shape to the bus electrode Yb. The light-absorbing layer 61, 62 contains a black or dark pigment. A dielectric layer 11 extends on the rear surface of the front glass substrate 10 such that the dielectric layer 11 covers the transparent electrodes Xa and Ya, the light-absorbing layers 61 and 62, and the bus electrodes Xb and Yb.

As shown in FIGS. 6, 9 and 10, the column electrodes D extending in parallel in the vertical direction of the display screen are provided on the rear substrate 13. The column electrodes D are spaced from each other. A column electrode protecting layer (dielectric layer) 14 is also formed on the rear substrate 13. The column electrode protecting layer is white, and covers the column electrodes D. Horizontal walls 15A, separation walls 15B, and vertical walls 15C are formed on the column electrode protective layer 14. The horizontal wall 15A and vertical walls 15C serve as partition walls, which can be referred to as “partition wall matrix.” The horizontal walls 15A define the partition walls for the pixel cells in the vertical direction of the display screen, and the vertical walls 15C define the partition walls for the pixel cells in the horizontal direction of the display screen. In other words, an area defined by two adjacent horizontal walls 15A and two adjacent vertical walls 15C is a pixel cell PC (PC_{1,1} to PC_{1,m}), as best seen in FIG. 6. The separation wall 15B divides the pixel cell PC into the display discharge cell C1 and the control discharge cell C2. If the pixel cells PC are viewed in the horizontal direction of the display screen, the display discharge cells C1 are arranged next to each other, and the control discharge cells C2 are also arranged next to each other.

The heights of the horizontal wall 15A, separation wall 15B and vertical wall 15C are equal to each other. As shown in FIG. 7 and 10, an additional dielectric layer 12 is provided between the horizontal wall 15A and the dielectric layer 11 and between the vertical wall 15C and the dielectric layer 11. The additional dielectric layer 12 gives an additional height to the wall 15A (15C) to close a gap between the wall 15A (15C) and the dielectric layer 11. The additional dielectric layer 11 is not provided between the separation wall 15B and the dielectric layer 11. The surface of the additional dielectric layer 12 is covered with a protective layer (not shown) such as MgO, and the surface of the dielectric layer 11 which faces the space of the pixel cell PC is also covered with the protective layer such as MgO.

A discharge gas is sealed in the space of the pixel cell PC, and each of the display discharge cell C1 and control discharge cell C2 has a discharge space.

As illustrated in FIGS. 7 and 9, a phosphor (fluorescent) layer 16 is formed on those surfaces of the column electrode protective layer 14, horizontal wall 15A, separation wall 15B and vertical wall 15C which surrounds the discharge space of each display discharge cell C1. The fluorescent layer 16 has one of three colors, namely, red, green or blue. Each of the pixel cells PC has a predetermined color of fluorescent layer 16 to emit red, green or blue light.

As illustrated in FIGS. 7 and 10, a secondary electron emission material layer 30 is formed on those surfaces of the column electrode protection layer 14, horizontal wall 15A, separation wall 15B and vertical wall 15C which surrounds the discharge space of each control discharge cell C2. The secondary electron emission material layer 30 is made from a high-γ material, which has a low work function (for example, 4.2 eV or lower) and a high secondary electron emission coefficient. Materials used for the secondary electron emission material layer 30 are, for example, MgO, CaO, SrO, BaO, and other alkaline earth metal oxides; Cs₂O and other alkaline metal oxides; CaF₂, MgF₂, and other fluoride compounds;. TiO₂ and Y₂O₃; materials which have an increased secondary electron emission coefficient through crystal defects or impurity doping; diamond films; or carbon nanotubes.

The spacing between the separation wall 15B and dielectric layer 11 does not have the additional dielectric layer 12 and defines a gap r (FIG. 7) that communicates the discharge space of the display discharge cell C1 with the discharge space of the control discharge cell C2 in each pixel cell PC. When viewed in the horizontal direction of the display screen, the discharge spaces of the control discharge cells C2 are partitioned from each other by the vertical walls 15C and additional walls 12 (FIG. 8), but the discharge spaces of the display discharge cells C1 are communicated with each other (FIG. 8).

As described above, each of the pixel cells PC_{1,1} to PC_{n-1,m} on the PDP 50 has the display discharge cell C1 and control discharge cell C2, which are communicated with each other. Each of the row electrodes X₂ to Xₙ and row electrodes Y₁ to Yₙ₋₁ are used for two adjacent display lines. For instance, the row electrodes X₂ and Y₁ define one display line, and the row electrodes X₂ to Y₂ define a next display line so that the row electrodes X₂ is used for the two adjacent display lines.

The X electrode driver 51 applies driving pulses to the row electrodes X₁ to Xₙ of the PDP 50, according to a timing signal supplied by the driving control circuit 56. The Y electrode driver 53 applies driving pulses to the row electrodes Y₁ to Yₙ of the PDP 50, according to a timing signal supplied by the driving control circuit 56. The address driver 55 applies pixel data pulses to the column electrodes D₁ to Dₘ of the PDP 50, according to a timing signal supplied by the driving control circuit 56.

The drive control circuit 56 first converts each pixel of the input image signal into, for example, pixel data of 8 bits which represent luminance levels, and applies an error diffusion processing and a dither processing to the pixel data. For instance, in the error diffusion processing, the upper six bits of the pixel data is used as display data, and the remaining lower two bits thereof is used as error data. Then, the error data of the pixel data is weighted based on the surrounding pixels, and the result is reflected on the display data of the surrounding pixels. According to such operation, the pseudo luminance for the lower two bits in an original pixel is expressed by the surrounding pixels. Therefore, the 6-bit (not 8-bit) display data can express the luminance gradation sequence equivalent to the 8-bit pixel data. In this manner, the error-diffusion-processed pixel data of six bits is obtained by the error diffusion processing. Then, the dither processing is applied to the 6-bit error-diffusion-processed pixel data. In the dither processing, a plurality of pixels abutting with each other are defined as one pixel unit, and dither coefficients having different coefficient values are allocated to the error diffusion processed pixel data of the pixels within this one pixel unit, respectively, and the resulting data are added to each other to obtain the dither-added pixel data. As a result of such addition of the dither coefficients, if viewed as the pixel unit, the upper four bits of the dither-added pixel data is sufficient to express the luminance equivalent to the eight-bit pixel data.

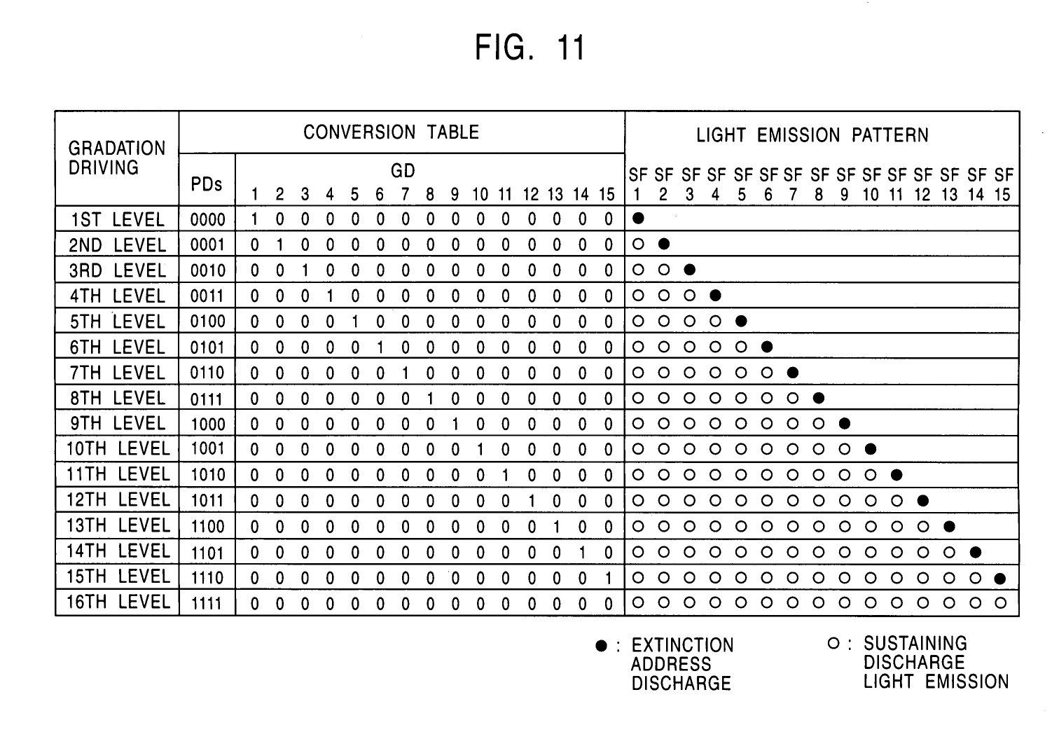

The drive control circuit 56 uses the error diffusion processing and dither processing to convert the 8-bit pixel data into 4-bit multi-gradation pixel data PDs and further converts this pixel data PDₛ into the 15-bit pixel driving data GD in accordance with a conversion table shown in FIG. 11. In this way, the pixel data which can express 256 gradation levels in eight bits is converted into the pixel driving data GD of fifteen bits including sixteen patterns in total. Subsequently, the drive control circuit 56 divides the pixel driving data GD_{1,1} to GD_{(n-1),m} into pixel driving data bit groups DB1 to DB15 for the odd display lines and even display lines. The pixel driving data GD_{1,1} to GD_{(n-1),m} are used for one screen, and the drive control circuit 56 divides (groups) the pixel driving data GD_{1,1} to GD_{(n-1),m} in terms of bit-digit. The drive control circuit 56 performs this grouping for every screen. The drive control circuit 56 supplies m data bit from the pixel driving data bit group DB of the subfield SF concerned, to the address driver 55 for one display line at a time. The pixel driving data bit group is supplied for each of the subfields SF1 to SF15.

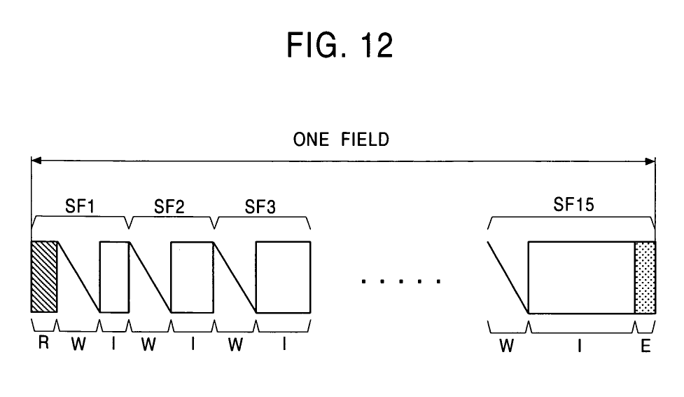

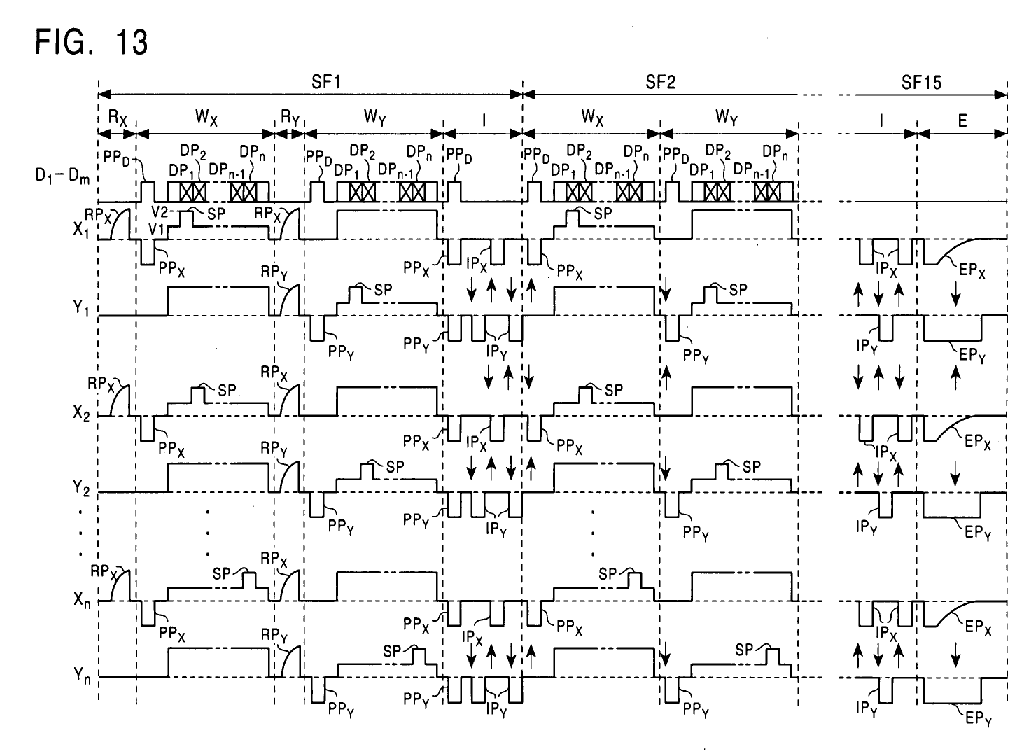

FIG. 12 shows a light emitting driving sequence when the PDP 50 is operated to create halftone colors by the selective erase (extinction, elimination) addressing method.

In the light emission driving sequence shown in FIG. 12, each field of the image signal is divided into fifteen subfields SF1 to SF15, and the addressing process W and light emission sustaining process I are carried out in each subfield. It should be noted that the field is divided into fifteen subfields in this embodiment, but the present invention is not limited in this regard.

In the first subfield SF1, the reset process R takes place prior to the address process W. In the last subfield SF15, the erase (extinction) process E is performed immediately after the light emission sustaining process I. In each subfield, the addressing W_{X} in the address process W is applied to the row electrodes X₁ to Xₙ and then the addressing W_{Y} in the address process W is applied to the row electrodes Y₁, to Yₙ. Likewise, in the reset process of the first subfield SF1, the resetting Rₓ is performed to the row electrodes X₁ to Xₙ and then the resetting R_{Y} is performed to the row electrodes Y₁ to Yₙ.

FIG. 13 shows the various driving pulses applied to the PDP 50 in the reset process R_{X}, R_{Y} the address process W_{X}, W_{Y}, and the light emission sustaining process I by the X electrode driver 51 and the Y electrode driver 53 based on the driving sequence of FIG. 12. In FIG. 13, the first subfield SF1 is entirely shown, and part of the second subfield SF2 and part of the last subfield SF15 are respectively shown.

In the reset process Rx of the X electrodes, the X electrode driver 51 generates positive-voltage reset pulses RP_{X} having a gentle rising edge, and applies these reset pulses RP_{X} to the row electrodes X₁ to Xₙ of the PDP 50 simultaneously. In response to the reset pulses RPₓ, reset discharge is induced across the row electrodes X₁ to Xₙ and column electrodes D within each of the control discharge cells C2 of the pixel cells PC related to the row electrodes X₁ to Xₙ. As a result of this reset discharge, a wall charge is created in each of the control discharge cells C2 concerned.

In the addressing process Wx of the X electrodes, the X electrode driver 51 applies negative-polarity inversion pulses PPx to the row electrodes X₁ to Xₙ simultaneously, immediately after the reset pulses RP_{X} The address driver 55 generates positive inversion pulses PP_{D} at the same time the inversion pulses PP_{X} are generated. The address driver 55 then applies the positive inversion pulses PP_{D} to the column electrodes D₁ to Dₘ simultaneously. Upon application of the inversion pulses PP_{X} and PP_{D}, discharge is induced across each of the row electrodes X₁, to Xₙ (bus electrodes Xb) and the associated column electrode D within each of the control discharge cells C2 of the pixel cells PC related to the row electrodes X₁ to Xₙ. As a result of this discharge, the polarity of the wall charge is reversed so that a negative charge is formed on the column electrodes and a positive charge is formed on the bus electrodes Xb.

After the above described polarity inversion, the X electrode driver 51 applies a positive voltage V1 to all the row electrodes X₁ to Xₙ and also applies scanning pulses SP having a positive voltage V2 (V2>V1) to the row electrodes X₁ to Xₙ sequentially. In the meantime, the Y electrode driver 53 applies a predetermined positive voltage to the row electrodes Y₁ to Yₙ. The address driver 55 converts the data bits of the pixel driving data bit group DB1 for the odd lines associated with the first subfield SF1, into pixel data pulses DP having pulse voltages determined by logic levels of the data bits. For example, the address driver 55 converts the pixel driving data bit having a logic level “0” into a positive high-voltage pixel data pulse DP whereas the address driver 55 converts the pixel driving data bit having a logic level “1” into a low (e.g., zero V) pixel data pulse DP. The address driver 55 then applies m pixel data pulses DP to the column electrodes D₁ to Dₘ, for one display line at a time, in synchronization with the scanning pulses SP. Specifically, the address driver 55 first applies the pixel data pulse group DP₁, which includes m pixel data pulses DP for the first display line, to the column electrodes D₁ to Dₘ. Then, the address driver 55 applies the pixel data pulse group DP₃, which includes m pixel data pulses DP for the third display line, to the column electrodes D₁ to Dₘ. The address driver 55 applies a similar pixel data pulse group to the column electrodes for the remaining odd display lines. The extinction address discharge is induced across the bus electrodes Xb and the column electrodes D in the control discharge cells C2 of those pixel cells PC to which the scanning pulses SP having the positive voltage V2 and the low-voltage pixel data pulses DP are applied together. The extinction address discharge propagates to the display discharge cell C1 from the control discharge cell C2 via the gap r (FIG. 7) so that discharge occurs between the row electrode Xa and the row electrode Ya having the predetermined voltage, in the display discharge cell C1. Because of the propagation of the discharge from the control discharge cell C2 to the display discharge cell C1, the wall charge is eliminated in the display discharge cell C1. On the other hand, the extinction address discharge is not induced in the control discharge cells C2 of those pixel cells PC to which the scanning pulses SP are applied and the high-voltage pixel data pulses DP are applied. Therefore, no discharge propagates to the display discharge cell C1 from the control discharge cell C2, and the presence/absence of the wall charge is maintained in the display discharge cell C1. Specifically, if there is a wall charge in the display discharge cell C1, the wall charge remains. If there is no wall charge in the display discharge cell C1, this “no wall charge ” situation is maintained.

In the reset process Ry of the Y electrodes, the X electrode driver 51 generates positive reset pulses RP_{X} having a gentle rising edge, and applies these reset pulses RP_{X} to the row electrodes X₁ to Xₙ of the PDP 50 simultaneously. The Y electrode driver 53 generates positive reset pulses RP_{Y} having a gentle rising edge, and apply these reset pulses RP_{Y} to the row electrodes Y₁ to Yₙ the PDP 50 simultaneously. The reset pulses RP_{X} in the Y electrode reset process Ry are dummy pulses, and do not induce discharge. On the other hand, the reset pulses RPy induce the reset discharge across the column electrodes D and the row electrodes Y₁ to Yₙ in the control discharge cells C2 of the pixel cells PC related to the row electrodes Y₁ to Yₙ. As a result of this reset discharge, a wall charge is created in each of the control discharge cells C2 related to the row electrodes Y₁ to Yₙ.

In the addressing process Wy of the Y electrodes, the Y electrode driver 53 applies negative inversion pulses PPy to the row electrodes Y₁ to Yₙ simultaneously, immediately after the reset pulses RP_{Y}. The address driver 55 generates positive inversion pulses PP_{D} at the same time the inversion pulses PP_{Y} are generated. The address driver 55 then applies the positive inversion pulses PP_{D} to the column electrodes D₁ to Dₘ of the PDP 50 simultaneously. Upon application of the inversion pulses PP_{Y} and PP_{D} discharge is induced across the row electrodes Y₁ to Yₙ (bus electrodes Yb) and column electrodes D within the control discharge cells C2 of the pixel cells PC related to the row electrodes Y₁ to Yₙ. As a result of this discharge, the polarity of the wall charge is reversed so that a negative charge is formed on the column electrodes and a positive charge is formed on the bus electrodes Yb.

After that, the Y electrode addressing process Wy is performed. The Y electrode driver 53 applies the positive voltage V1 to all the row electrodes Y₁ to Yₙ and also applies the scanning pulses SP having the positive voltage V2 (V2>V1) to the row electrodes Y₁ to Yₙ sequentially. In the meantime, the X electrode driver 51 applies a predetermined positive voltage to the row electrodes X₁ to Xₙ. The address driver 55 converts the data bits of the pixel driving data bit group DB1 for the even lines associated with the first subfield SF1, into pixel data pulses DP having pulse voltages determined by logic levels of the data bits. The address driver 55 then applies m pixel data pulses DP to the column electrodes D₁ to Dₘ, for one display line at a time, in synchronization with the scanning pulses SP. Specifically, the address driver 55 first applies the pixel data pulse group DP₂, which includes m pixel data pulses DP for the second display line, to the column electrodes D₁ to Dₘ. Then, the address driver 55 applies the pixel data pulse group DP₄, which includes m pixel data pulses DP for the fourth display line, to the column electrodes D₁ to Dₘ. The address driver 55 applies a similar pixel data pulse group to the column electrodes for the remaining even display lines. The extinction address discharge is induced across the bus electrodes Yb and the column electrodes D in the control discharge cells C2 of those pixel cells PC to which the scanning pulses SP having the positive voltage V2 and the low-voltage pixel data pulses DP are applied together. The extinction address discharge propagates to the display discharge cell C1 from the control discharge cell C2 via the gap r (FIG. 7) so that another discharge occurs between the row electrode Xa having the predetermined voltage and the row electrode Ya, in the display discharge cell C1. Because of the propagation of the discharge from the control discharge cell C2 to the display discharge cell C1, the wall charge is eliminated in the display discharge cell C1. On the other hand, the extinction address discharge is not induced in the control discharge cells C2 of those pixel cells PC to which the scanning pulses SP are applied and the high-voltage pixel data pulses DP are applied. Therefore, no discharge propagates to the display discharge cell C1 from the control discharge cell C2, and the presence/absence of the wall charge is maintained in the display discharge cell C1.

As described above, in the addressing processes W_{X} and W_{Y} of the selective extinction addressing method, the extinction address discharge is selectively caused in the control discharge cells C2 of the pixel cells PC depending upon the data bits in the pixel driving data bit group associated with the subfield concerned, so that the wall charge is selectively eliminated from the display discharge cells C1. In this manner, the pixel cells PC having the wall charge are set to the lit state and the pixel cells PC having no wall charge are set to the extinguished state.

At the beginning of the sustaining process I subsequent to the addressing process Wy in the first subfield SF1, the X electrode driver 51 generates a negative inversion pulses PP_{X} and applies them to the row electrodes X₁ to Xₙ simultaneously, and the Y electrode driver 53 generates a negative inversion pulses PP_{Y} and applies them to the row electrodes Y₁ to Yₙ simultaneously. At the same time the inversion pulses PP_{X} and PP_{Y} are applied, the address driver 55 generates positive inversion pulses PP_{D} and applies them to the column electrodes D₁ to Dₘ simultaneously.

In those pixel cells which maintain the wall charge in the X and Y electrode addressing processes W_{X} and W_{Y}, the charge has positive polarity on the column electrodes D₁ to Dₘ and has negative polarity on the row electrodes X₁ to Xₙ and Y₁ to Yₙ. Because of the application of the polarity inversion pulses PP_{X}, PP_{Y} and PP_{D}, the polarity of the charge on the row electrodes X₁ to Xₙ is inverted to the positive, and the charge on the row electrodes Y₁ to Yₙ maintain the negative polarity.

In the next process, i.e., the sustaining process I, the Y electrode driver 53 repeatedly applies a negative sustain pulse IP_{Y} to the row electrodes Y₁ to Yₙ. The X electrode driver 51 repeatedly applies a negative sustain pulse IP_{X} to the row electrodes X₁ to Xₙ. The sustain pulses are alternately applied to the row electrodes Y₁ to Yₙ and the row electrodes X₁ to Xₙ. How many times the sustain pulse application is repeated is determined by the number allotted to the subfield associated with the sustaining process I. As the sustain pulses IP_{X} or IP_{Y} are applied, sustain discharge is induced across the transparent electrodes Xa and Ya within each of the display discharges cells C1 of those pixel cell PC which are set to the lit state. In FIG. 13, the direction of the current generated by the sustain discharge is indicated by the arrow. Due to the ultraviolet light produced by the sustain discharge, the fluorescent layer 16 (red fluorescent layer, green fluorescent layer, blue fluorescent layer) formed in the display discharge cell C1 (FIG. 7) is excited, and light corresponding to the fluorescence color is irradiated through the front glass substrate 10. That is, light emission is repeatedly induced by the sustain discharge the number of times allocated to the subfield having the sustaining process I concerned.

A negative wall charge is generated in the discharge space of each of the display discharge cells C1 of those pixel cells PC which are set to the lit state by the negative sustain pulses IP_{X} and IP_{Y}. The wall charge is generated in the vicinity of the column electrode D. Each sustaining process I is complete when the sustain pulses IP_{Y} are applied to the row electrodes Y₁ to Yₙ. As a result, a positive wall charge is generated in the discharge space below the row electrodes Y₁ to Yₙ.

Referring to FIG. 12, when the subfield SF2 is executed after the subfield SF1, the above described X electrode addressing process Wx, Y electrode addressing process Wy and sustain process I are performed immediately. In the subsequent subfields, the same processes are carried out.

In the extinction process E of the 15th or last subfield SF15, the X electrode driver 51 generates negative extinction pulses EP_{X} and applies them to the row electrodes X₁ to Xₙ. At the same time, the Y electrode driver 53 generates negative extinction pulses EP_{Y} and applies them to the row electrodes Y₁ to Yₙ. The extinction pulses EP_{X} and EP_{Y} are applied for a predetermined period. The voltage of the extinction pulse EP_{X} approaches zero V from a predetermined extinction voltage as the time passes. The extinction pulse EP_{X} becomes zero V when a predetermined time elapses. On the other hand, the extinction pulse EP_{Y} maintains a predetermined extinction voltage for a predetermined period. The extinction pulses EP_{X} and EP_{Y} induce the extinction discharge between the row electrodes X and Y so that the wall charge is eliminated from the display discharge cells C1 and control discharge cells C2. Accordingly, all the pixel cells PC in the PDP 50 are brought into the extinction state.

It should be noted that the sustaining process I just before the extinction process E in the 15th subfield SF15 is different from the sustaining process I in other subfields. Specifically, in the sustaining process I of the subfield SF15, the sustaining process I is finished when the negative sustain pulses IP_{X} are applied to the row electrodes X₁ to Xₙ.

The PDP 50 is operated using the reset processes R (Rx, Ry), addressing processes W (Wx, Wy) and sustaining processes I as shown in FIGS. 12 and 13, based on the sixteen pixel driving data GD shown in FIG. 11. When the selective extinction address method as shown in FIGS. 12 and 13 is employed, the reset processes Rx and Ry of the subfield SF1 are the only opportunities, among the subfield SF1 to the subfield SF15, that can shift the pixel cells PC from the extinction mode to the lit mode. Therefore, if the extinction address discharge is induced in a certain subfield among the subfields SF1 to SF15 and the pixel cell PC concerned is set to the extinction mode, then this pixel cell PC never returns to the lit mode in the subsequent subfields. Accordingly, when the PDP 50 is driven with the 16 pixel driving data GD shown in FIG. 11, each pixel cell PC is maintained to the lit mode for a period determined by a particular number of continuous subfields. This “particular number” is determined by the brightness or luminance to be expressed. Until the extinction address discharge, indicated by the black circle in FIG. 11, is induced, the light emission of the sustain discharge, indicated by the white circle, is induced consecutively in the sustaining processes I of the subfields.

Consequently, the brightness, which corresponds to the total number of discharge triggered in one field, is perceived. Specifically, when the sixteen kinds of light emission pattern are provided by the first to sixteenth gradation level driving shown in FIG. 11, it is possible to create (or express) sixteen halftone levels depending upon the total number of sustain discharge induced in the white-circle subfields.

In order to induce the extinction address discharge during the addressing processes W_{X} and W_{Y} in the selective extinction address method, the scan pulses SP having the positive voltage V2 are applied to the row electrodes Y and a low voltage (zero V) pixel data pulses DP are applied to the column electrodes D. Thus, the column electrode D has a lower voltage than the row electrode Y in the control discharge cell C2, and the secondary electron emission layer 30 formed in the control discharge cell C2 becomes a cathode relative to the row electrode Y. Therefore, when the extinction address discharge takes place, the secondary electron emission layer 30 can sufficiently emit secondary electron. This ensues that the extinction address discharge successfully takes place in the control discharge cell C2.

In the foregoing, the N+1 halftone driving which can present N+1 gradation levels is described using the N subfields. N is 15 in the above described embodiment. It should be noted that a similar operation can be applied when 2^{N} halftone driving is carried out with the N subfields.

In this embodiment, it is possible to reduce the display line pitch so that the contrast and fineness are enhanced.

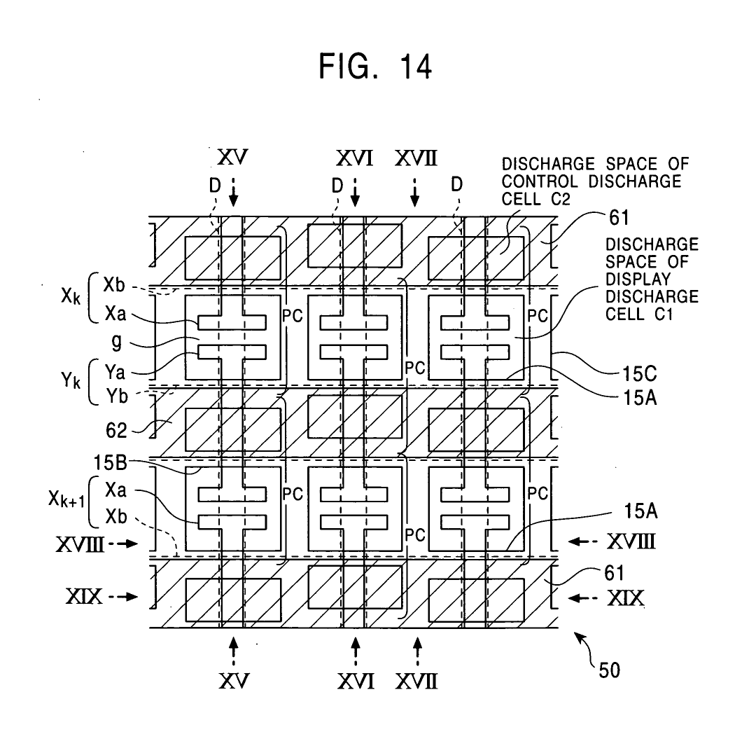

FIGS. 14 to 19 depict another embodiment of the present invention. Similar reference numerals are used in FIGS. 6 to 19.

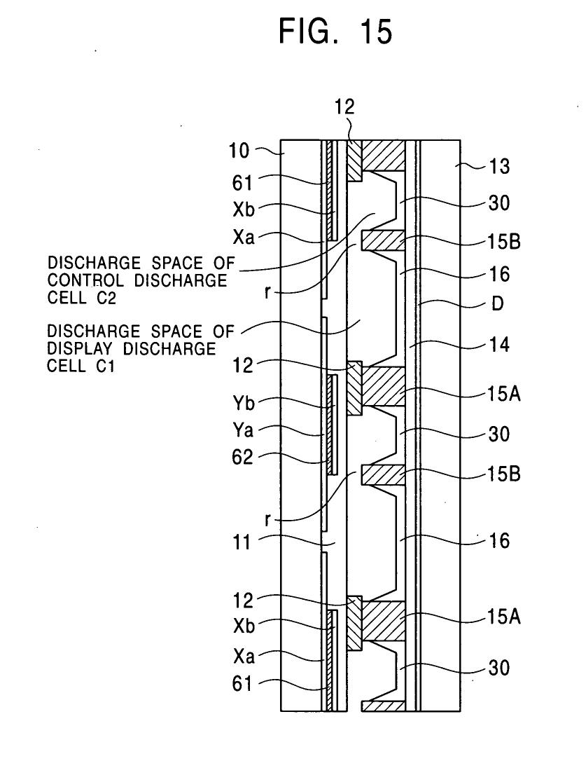

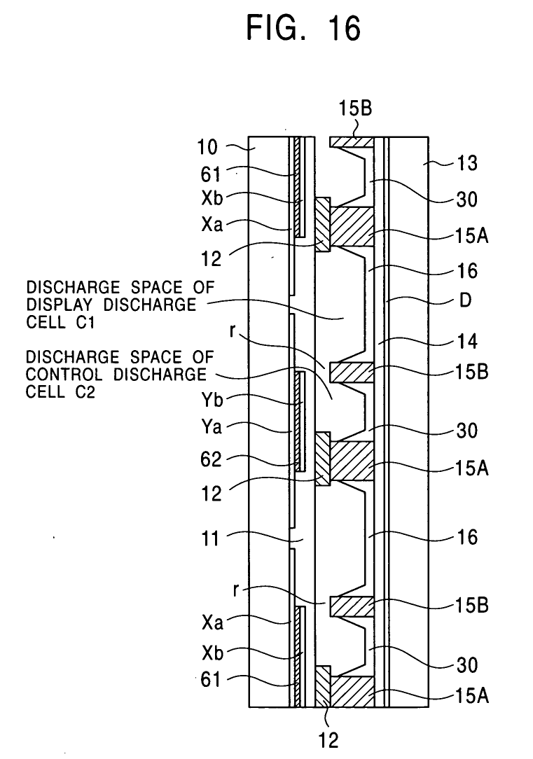

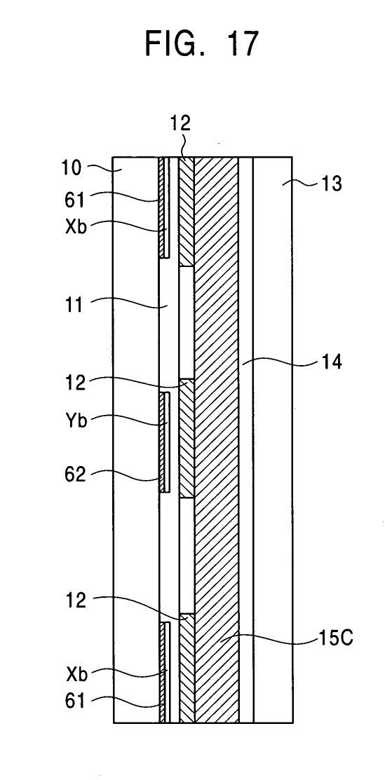

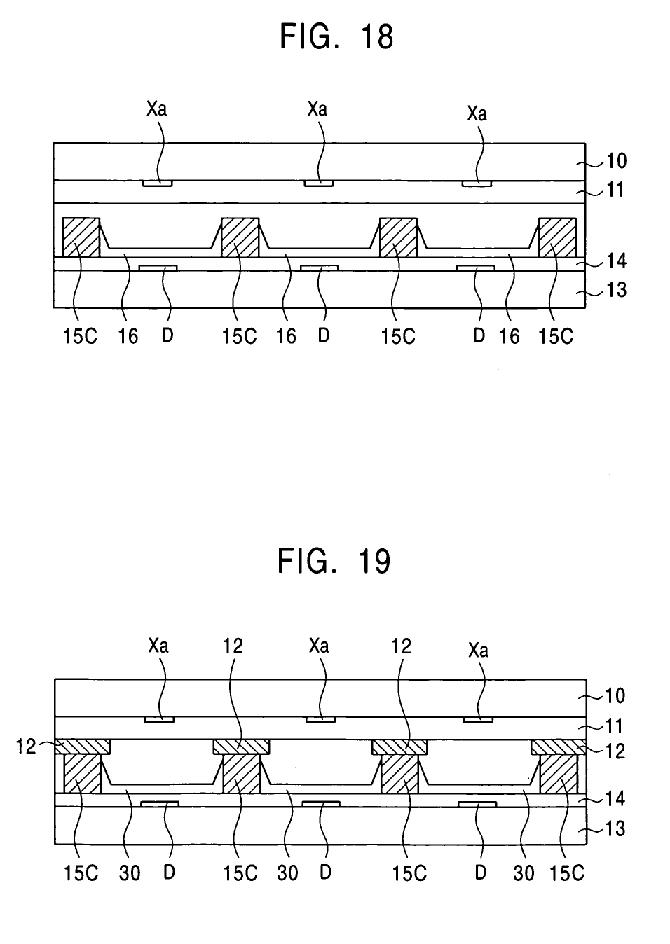

FIG. 14 is a plan view of a part of the PDP 50, when viewed from the front side. FIG. 15 illustrates a cross sectional view of the PDP 50 of FIG. 14 taken along the line XV-XV in FIG. 14. FIG. 16 illustrates a cross sectional view of the PDP 50 taken along the line XVI-XVI in FIG. 14. FIG. 17 illustrates a cross sectional view of the PDP 50 taken along the line XVII-XVII in FIG. 14. FIG. 18 illustrates a cross sectional view of the PDP 50 taken along the line XVIII-XVIII in FIG. 14. FIG. 19 illustrates a cross sectional view of the PDP 50 taken along the line XIX-XIX in FIG. 14.

In this second embodiment, the PDP 50 has two types of pixel cells PC. Each pixel cell PC includes a display discharge cell C1 and a control discharge cell C2. The display discharge cells C1 are arranged linearly in the horizontal direction of the display screen for each display line, but the control discharge cells C2 paired with the display discharge cells C1 are not arranged linearly. As best understood from FIG. 14, the display discharge cell C1 below the arrow XVI is paired with the lower control discharge cell C2 to define the pixel cell PC, and the display discharge cell C1 below the arrow XV is paired with the upper control discharge cell C2 to define the pixel cell PC. Thus, every other display discharge cells C1 are paired with lower control discharge cells C2 when viewed in the horizontal direction of the display screen, and the other every other display cells C1 are paired with upper control discharge cells C2. The horizontal wall 15A extends between the display discharge cell C1 and the control discharge cell C2 if these two cells are not paired to form the pixel cell PC. The separation wall 15B, which is thinner (narrower) than the horizontal wall 15A, extends between the display discharge cell C1 and the control discharge cell C2 if these two cells are paired to form the pixel cell PC. In addition, the discharge spaces of the control discharge cells C2 are not linearly arranged when viewed in the horizontal direction of the display screen. Similar to the PDP 50 shown in FIGS. 6 to 10, the gap r is left between the separation wall 15B and the dielectric layer 11 so that the discharge space of the display discharge cell C1 is communicated with the discharge space of the control discharge cell C2 via the gap r.

Other structure of the PDP 50 of the second embodiment is the same as the PDP 50 of the first embodiment shown in FIGS. 6 to 10.

Similar to the PDP of the first embodiment, it is possible to reduce the display line pitch so that the contrast and fineness are enhanced.

This application is based on a Japanese patent application No. 2003-47176, and the entire disclosure thereof is incorporated herein by reference.

What is claimed is:

1. A plasma display panel having a row direction and a column direction, the row direction corresponding to a display line direction of the plasma display panel, comprising:
a front substrate having an outer surface and an inner surface;
a plurality of row electrodes extending in the row direction on the inner surface of the front substrate, the plurality of row electrodes being parallel to each other and spaced from each other in the column direction, each display line of the plasma display panel being defined by paired two adjacent row electrodes, one of each said paired two adjacent row electrodes being used in a next paired two adjacent row electrodes to define a next display line;
a rear substrate having an outer surface and an inner surface such that the inner surface of the rear substrate faces the inner surface of the front substrate, a discharge space being formed between the inner surface of the front substrate and the inner surface of the rear substrate;
a dielectric layer formed on the inner surface of the front substrate for covering the plurality of row electrodes;
a plurality of column electrodes extending in the column direction on the inner surface of the rear substrate, the plurality of column electrodes being parallel to each other and spaced from each other in the row direction;
a plurality of unit light-emission areas formed in the discharge space at intersections of the plurality of row electrodes and column electrodes such that two said row electrodes and one said column electrode are associated with each said unit light-emission area;
a partition wall matrix provided between the front and rear substrates for partitioning the plurality of unit light-emission areas from each other;
a plurality of separation walls provided between the front and rear substrates such that each said separation wall divides each said unit light-emission area into a first discharge cell, in which discharge occurs across the paired two adjacent row electrodes associated with the each unit light-emission area, and a second discharge cell, in which discharge occurs across one of the paired two adjacent row electrodes and the column electrode associated with the each unit light-emission area; and
a plurality of passages formed in the plurality of unit light-emission areas respectively, such that each said passage communicates the first discharge cell with the second discharge cell of each said unit light-emission area.

2. The plasma display panel according to claim 1, wherein each of the plurality of row electrodes includes a main portion extending in the row direction, and a plurality of two branching portions extending oppositely from the main portion in the column direction, one of the two branching portions of each said row electrode extends in the unit light-emission area concerned, the other branching portion extends in an adjacent unit light-emission area of the column direction, each said branching portion extends toward another branching portion extending from an adjacent row electrode, and each said branching portion has a T shape and has a free end, and
wherein the free end of each said branching portion is exposed to the free end of an adjacent branching portion over a first discharge gap in each said first discharge cell, and the main portion of each said row electrode is exposed to the associated column electrode over a second discharge gap in each said second discharge cell.

3. The plasma display panel according to claim 1 further including a black layer provided on the inner surface of the front substrate in each said second discharge cell.

4. The plasma display panel according to claim 1 further including a secondary electron emission layer provided on the inner surface of the rear substrate in each said second discharge cell.

5. The plasma display panel according to claim 1 further including a fluorescent layer formed on only the inner surface of the front substrate in each said first discharge cell.

6. A display device for displaying an image corresponding to an input image signal, based on pixel data of pixels derived from the input image signal, the display device being operated with a plurality of subfields, the plurality of subfields being obtained by dividing one field display period by a certain number, each of the plurality of subfields including an addressing interval and a sustain interval, the plurality of subfields consisting of a first subfield to a last subfield, the display device comprising:
a plasma display panel having a row direction and a column direction, the row direction corresponding to a display line direction of the plasma display panel, the plasma display panel including:
a front substrate having an outer surface and an inner surface,
a plurality of row electrodes extending in the row direction on the inner surface of the front substrate, the plurality of row electrodes being parallel to each other and spaced from each other in the column direction, each display line of the plasma display panel being defined by paired two adjacent row electrodes, the plurality of row electrodes defining a first display line to a last display line, one of each said paired two adjacent row electrodes being used in a next paired two adjacent row electrodes to define a next display line,
a rear substrate having an outer surface and an inner surface such that the inner surface of the rear substrate faces the inner surface of the front substrate, a discharge space being formed between the inner surface of the front substrate and the inner surface of the rear substrate,
a dielectric layer formed on the inner surface of the front substrate for covering the plurality of row electrodes,
a plurality of column electrodes extending in the column direction on the inner surface of the rear substrate, the plurality of column electrodes being parallel to each other and spaced from each other in the row direction,
a plurality of unit light-emission areas formed in the discharge space at intersections of the plurality of row electrodes and column electrodes such that two said row electrodes and one said column electrode are associated with each said unit light-emission area,
a partition wall matrix provided between the front and rear substrates for partitioning the plurality of unit light-emission areas from each other,
a plurality of separation walls provided between the front and rear substrates such that each said separation wall divides each said unit light-emission area into a first discharge cell, in which discharge occurs across the paired two adjacent row electrodes associated with the each unit light-emission area, and a second discharge cell, in which discharge occurs across one of the paired two adjacent row electrodes and the column electrode associated with the each unit light-emission area, and
a plurality of passages formed in the plurality of unit light-emission areas respectively, such that each said passage communicates the first discharge cell with the second discharge cell of each said unit light-emission area;
an addressing circuit for applying a positive scan pulse to one of each said paired two adjacent row electrodes in the address interval from the first display line to the last display line sequentially, and for applying pixel data pulses derived from the pixel data to the plurality of column electrodes, for one display line at a time, in synchronization with the positive scan pulse when the plurality of column electrodes are a cathode, thereby selectively inducing address discharge in the second discharge cells; and
a sustaining circuit for applying a sustain pulse to each said paired two adjacent row electrodes in the sustain interval.

7. The display device according to claim 6, wherein the sustaining circuit applies the sustain pulse, having a negative polarity, to said one of each said paired two adjacent row electrodes for all the display lines in the sustain interval of the last subfield.

8. The display device according to claim 6, wherein the addressing circuit causes the induced address discharge to propagate from the second discharge cells to the associated first discharge cells, thereby setting the first discharge cells into a lit condition or an extinguished condition.

9. The display device according to claim 6, wherein each of the plurality of row electrodes includes a main portion extending in the row direction, and a plurality of two branching portions extending oppositely from the main portion in the column direction, one of the two branching portions of each said row electrode extends in the unit light-emission area concerned, the other branching portion extends in an adjacent unit light-emission area of the column direction, each said branching portion extends toward another branching portion extending from an adjacent row electrode, and each said branching portion has a T shape and has a free end, and
wherein the free end of each said branching portion is exposed to the free end of an adjacent branching portion over a first discharge gap in each said first discharge cell, and the main portion of each said row electrode is exposed to the associated column electrode over a second discharge gap in each said second discharge cell.

10. The display device according to claim 6 further including a black layer provided on the inner surface of the front substrate in each said second discharge cell.

11. The display device according to claim 6 further including a secondary electron emission layer provided on the inner surface of the rear substrate in each said second discharge cell.

12. The display device according to claim 6 further including a fluorescent layer formed on only the inner surface of the front substrate in each said first discharge cell.

13. The display device according to claim 6, wherein discharge spaces of the second discharge cells are completely comparted from each other by the partition wall matrix, and each said discharge space of each said second discharge cell is communicated with a discharge space of said first discharge cell in an adjacent unit light-emission area of the row direction.

14. The display device according to claim 6 further including a reset circuit for applying a reset pulse to said one of each said paired two adjacent row electrodes and the column electrodes, prior to the address discharge of the addressing circuit, thereby inducing reset discharge in the second discharge cell concerned.

15. The display device according to claim 14, wherein the reset pulse has a waveform which changes gentler than the sustain pulse in a rising edge and a falling edge.

16. The display device according to claim 14, wherein the reset circuit induces the reset discharge in odd display lines and in even display lines at different timing.

17. The display device according to claim 6, wherein the addressing circuit induces the address discharge in odd display lines and in even display lines at different timing.
